(19) United States
(12) Patent Application Publication
(10) Pub. No.: US 2015/0160016 A1
(43) Pub. Date: Jun. 11, 2015

(54) OPTIMIZING MAP DATA BASED ON FINANCIAL TRANSACTIONS

(71) Applicant: fisoc, Inc., Austin, TX (US)

(72) Inventors: Daniel Edward Kim, Austin, TX (US); Jay P. Valanju, Austin, TX (US); Brian Rainey, Austin, TX (US)

(21) Appl. No.: 14/561,864

(22) Filed: Dec. 5, 2014

Related U.S. Application Data
(60) Provisional application No. 61/912,164, filed on Dec. 5, 2013.

(51) Int. Cl. G01C 21/00; G01S 19/13

(52) U.S. Cl. CPC G01C 21/00; G01S 19/13

(57) ABSTRACT

A mobile device includes a memory storing applications, a processor communicating with the memory and executing the applications, and a GPS tool cooperable with the processor and accessing geolocation data of the mobile device. The GPS tool identifies a commerce range for the mobile device. A user interface communicates with the processor, and a display is cooperable with the user interface and communicates with the processor. The applications include a map tool that is cooperable with the GPS tool and the processor such that the processor displays a map on the display at a zoom level that is determined based on the commerce range.

### CROSS-REFERENCES TO RELATED APPLICATIONS

This application claims the benefit of U.S. Provisional Patent Application Ser. No. 61/912,164, filed Dec. 5, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The application relates generally to map display applications for mobile devices and, more particularly, to optimizing map data based on user financial transactions.

In many map based applications (for example a Merchant Directory) the initial view is set to a default value (for example: 25×25 miles, centered on the user's current location). This initial view is usually suboptimal requiring the user to change map resolutions. This causes frustration for the user (because of poor user experience) and causes unnecessary calls to the gis infrastructure. It is difficult to choose an application wide default because the context in which the user is using the application differs from user to user and also time of day. Other attempts at solving this problem include defaulting to the last known settings, but that has its own problems as well. For example, typically, a map search is iterative, and it is not ideal to start the iterative search at a default or last known setting.

### BRIEF SUMMARY OF THE INVENTION

A solution to improve the performance of the mobile device is to modify or optimize the map data based on user financial transactions. That is, the system can compute a natural or “normal” spending range of the user, which may be bucketed by time. When a user requests the map view, the viewing range or zoom level is defaulted to the natural spend range when the user is currently located in that range. If the user is not in their spend range, then a default configuration may be used. The spend range may be defined by the bounds of the user's shopping area. The range can be defined by a time slice, where the bounds of the typical transaction vary across different time periods. This threshold can be tuned to the particular needs of the application or tuned to the natural variance of user spend patterns. For example, if a person regularly visits a number of merchants over a time period, the default resolution of the map would be the bounds of the regular transaction location. This default resolution may be slightly expanded to include an arbitrary margin. The data can be factored around time ranges to incorporate use cases (e.g., lunch time, dinner time, weekend, etc.).

In an exemplary embodiment, a mobile device includes a memory storing applications, a processor communicating with the memory and executing the applications, and a GPS tool cooperable with the processor and accessing geolocation data of the mobile device. The GPS tool identifies a commerce range for the mobile device. A user interface communicates with the processor, and a display is cooperable with the user interface and communicates with the processor. The applications include a map tool that is cooperable with the GPS tool and the processor such that the processor displays a map on the display at a zoom level that is determined based on the commerce range. The GPS tool may communicate with the memory to store the geolocation data of the mobile device over a time period, and the processor may be programmed to define the commerce range based on the stored geolocation data. The processor may be programmed to set the zoom level of the map to encompass the commerce range plus a predefined margin, which may be 1-10 miles. The processor may be programmed to define different commerce ranges over different time periods of a day. In one embodiment, the applications include a credit/debit card tool cooperable with the GPS tool and the processor that identifies user conducted financial transactions and transaction geolocation data, where the GPS tool indentifies the commerce range based on the transaction geolocation data. The processor may be programmed to set the zoom level to a default zoom level when GPS tool indicates that the mobile device may be outside of the commerce range.

In another exemplary embodiment, a method of displaying map data on a mobile device based on financial transactions includes the steps of (a) the GPS tool accessing geolocation data of the mobile device; (b) the GPS tool identifying a commerce range for the mobile device; and (c) the map tool and the processor displaying a map on the display at a zoom level that may be determined based on the commerce range.

In yet another exemplary embodiment, a mobile device includes a memory storing applications, a processor communicating with the memory and executing the applications, and a GPS tool cooperable with the processor and accessing geolocation data of the mobile device. The GPS tool identifies a commerce range for the mobile device. The GPS tool communicates with the memory to store the geolocation data of the mobile device over a time period. The applications include a credit/debit card tool cooperable with the GPS tool and the processor that identifies user conducted financial transactions and transaction geolocation data. The GPS tool indentifies the commerce range based on the stored geolocation data and the transaction geolocation data. The applications further include a map tool that is cooperable with the GPS tool and the processor such that the processor displays a map on the display at a zoom level that may be determined based on the commerce range.

### BRIEF DESCRIPTION OF THE DRAWINGS

These and other aspects and advantages will be described in detail with reference to the accompanying drawings, in which:

FIG. 1 is a block diagram showing components of a mobile device;

FIG. 2 shows a map display defaults selection sequence; and

FIG. 3 is a schematic illustration of a computer system.

### DETAILED DESCRIPTION OF THE INVENTION

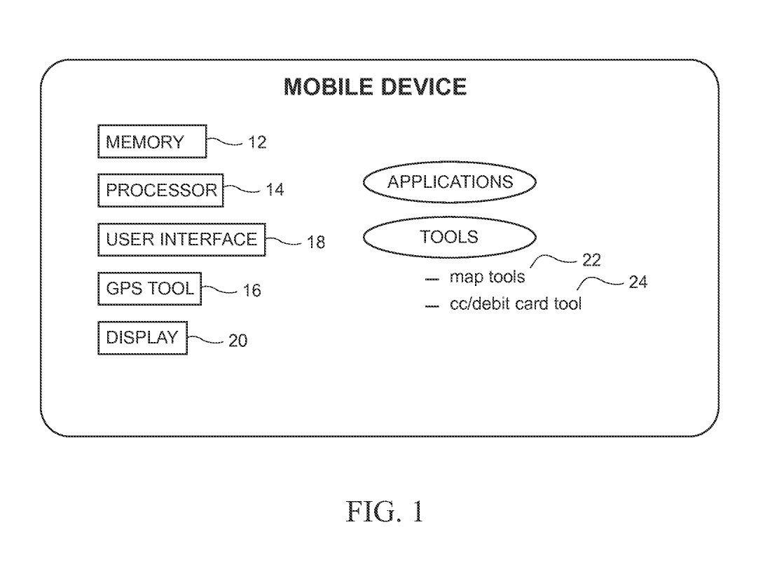

FIG. 1 is a schematic block diagram of a mobile device 10. The components and operation of such mobile devices are well known, and details of such structure and operation will not be described. Generally, the mobile device 10 includes a memory 12 storing applications, a processor 14 communicating with the memory 12 and executing the applications, and a GPS tool 16 cooperable with the processor 14 and accessing geolocation data of the mobile device 10. A user interface 18 communicates with the processor 14, and a display 20 is cooperable with the user interface and communicates with the processor 14.

Among the applications stored in the memory 12, a map tool 22 is cooperable with the GPS tool 16 and the processor 14 such that the processor 14 displays a map on the display 20. The cooperation between the GPS tool 16 and the map tool 22 for geolocation identification and map display is known. Generally, a map matching module or the like receives a number of GPS traces from a number of GPS trace sources. A “GPS trace” is meant to be understood broadly as any data defining the recent or past positions of a GPS system. Each GPS trace includes a sequence of GPS points comprising latitude, longitude, and time stamp or time-delta. Each GPS point may further include data describing the measured speed of the GPS system, the compass bearing at which the GPS system is directed toward, among others.

The map tool 22 is cooperable with the GPS tool 16 and the processor 14 to display a map when requested by a user at a particular zoom level. According to preferred embodiments of the invention, the zoom level is determined based on a natural spending range or commerce range of the user. The GPS tool 16 in cooperation with the processor 14 identifies the commerce range for the mobile device (user) based on the GPS traces at various times of day. That is, the GPS tool 16 may communicate with the memory 12 to store the geolocation data of the mobile device 10 over a time period. The processor 14 is programmed to define the commerce range based on the stored geolocation data.

In one arrangement, the processor is programmed to set the zoom level of the map to encompass the commerce range plus a predefined margin, e.g., 1-10 miles. For example, if a person regularly visits a number of merchants over a time period, the default resolution or zoom level of the map would be bound of the regular transaction location, and preferably plus the arbitrary margin. The time periods may be associated with specific times of day such as lunch time, dinner time and the like or specific times of the week, e.g., weekend.

This threshold can be tuned to the particular needs of the application or tuned to the natural variance of the user's spend patterns. For example, lunch time does not have to be noon; rather it can be a tight band of time where the user is most likely to have lunch, e.g., 1:30-2:45. These patterns may depend on usage and can be modified via specific use case (e.g., most likely times a user will have coffee) or a set time (e.g., 9 AM Saturday-11 PM Sunday).

If the user is not in the commerce range, then a default configuration is used when a map display is requested.

Among the tools stored in the memory 12 of the mobile device 10, a credit/debit card tool 24 may be cooperable with the GPS tool 16 and the processor 14 to identify user conducted financial transactions and transaction geolocation data. The system can distinguish between user stops when a financial transaction is conducted (with a credit/debit card) and user stops without such a transaction.

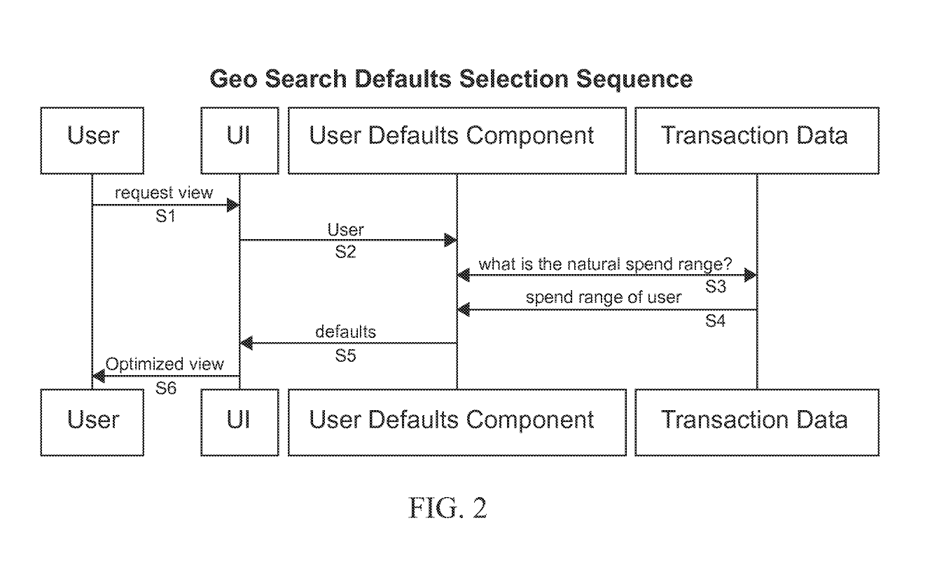

With reference to FIG. 2, once the commerce range is defined/identified by the GPS tool 16, when a user requests a map view (S1) via the user interface 18 and/or display 20, the system identifies the user (S2) and accesses the user's commerce range or natural spend range (S3). The system returns the spend range of the user (S4) and references display defaults (S5) and an optimized view based on the user's commerce range is displayed (S6). For example, an optimized view can include coordinate bounds of the map view that the user is probably most interested in.

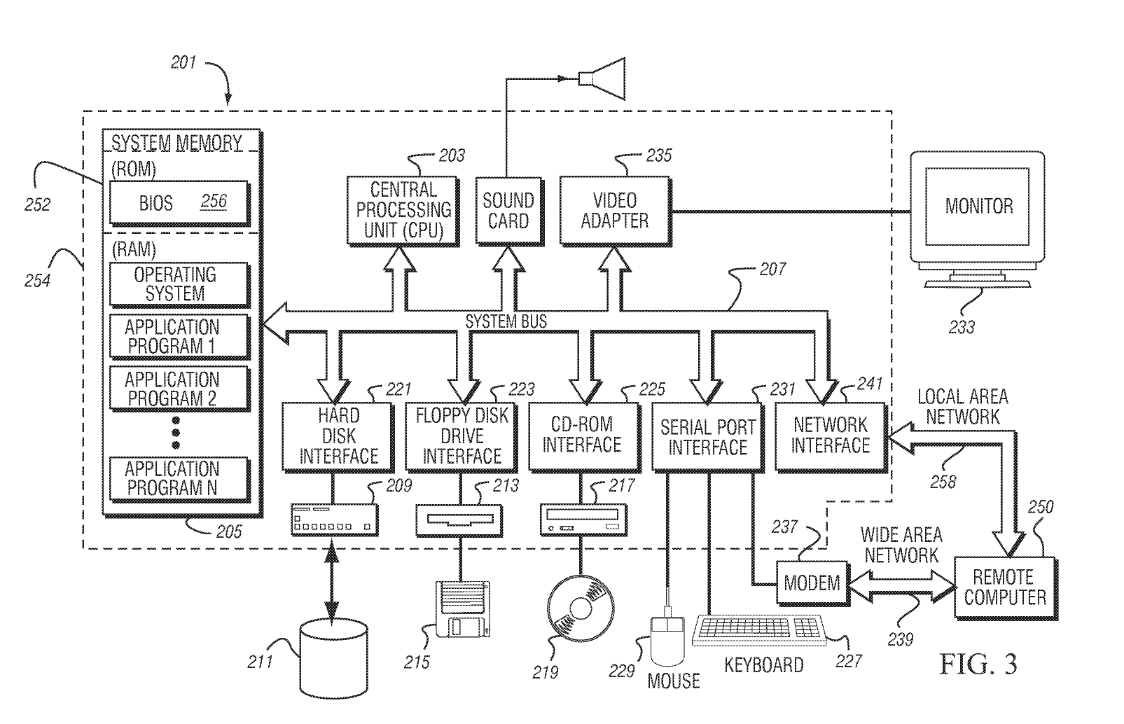

FIG. 3 illustrates an example of a suitable computing system/environment 201 on which aspects of the subject matter described herein may be implemented. The computing system environment 201 is only one example of a suitable computing environment and is not intended to suggest any limitation as to the scope of use or functionality of aspects of the subject matter described herein. Neither should the computing environment 201 be interpreted as having any dependency or requirement relating to any one or combination of components illustrated in the exemplary operating environment 201.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

It will be appreciated that the system will run appropriate software and that any client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard or touch screen keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A mobile device comprising:
a memory storing applications;
a processor communicating with the memory and executing the applications;
a GPS tool cooperable with the processor and accessing geolocation data of the mobile device, the GPS tool identifying a commerce range for the mobile device;
a user interface communicating with the processor; and
a display cooperable with the user interface and communicating with the processor,
wherein the applications comprise a map tool that is cooperable with the GPS tool and the processor such that the processor displays a map on the display at a zoom level that is determined based on the commerce range.

2. A mobile device according to claim 1, wherein the GPS tool communicates with the memory to store the geolocation data of the mobile device over a time period, and wherein the processor is programmed to define the commerce range based on the stored geolocation data.

3. A mobile device according to claim 2, wherein the processor is programmed to set the zoom level of the map to encompass the commerce range plus a predefined margin.

4. A mobile device according to claim 3, wherein the predefined margin is 1-10 miles.

5. A mobile device according to claim 2, wherein the processor is programmed to define different commerce ranges over different time periods of a day.

6. A mobile device according to claim 1, wherein the applications comprise a credit/debit card tool cooperable with the GPS tool and the processor that identifies user conducted financial transactions and transaction geolocation data, and wherein the GPS tool indentifies the commerce range based on the transaction geolocation data.

7. A mobile device according to claim 1, wherein the processor is programmed to set the zoom level to a default zoom level when GPS tool indicates that the mobile device is outside of the commerce range.

8. A method of displaying map data on a mobile device based on financial transactions, the mobile device including a memory storing applications, a processor communicating with the memory and executing the applications, a GPS tool cooperable with the processor, a user interface communicating with the processor, and a display cooperable with the user interface and communicating with the processor, wherein the applications comprise a map tool that is cooperable with the GPS tool and the processor, the method comprising:
(a) the GPS tool accessing geolocation data of the mobile device;
(b) the GPS tool identifying a commerce range for the mobile device; and
(c) the map tool and the processor displaying a map on the display at a zoom level that is determined based on the commerce range.

9. A method according to claim 8, wherein step (b) is practiced by the GPS tool communicating with the memory to store the geolocation data of the mobile device over a time period, and by the processor defining the commerce range based on the stored geolocation data.

10. A method according to claim 9, wherein step (c) is practiced by the processor setting the zoom level of the map to encompass the commerce range plus a predefined margin.

11. A method according to claim 10, wherein the predefined margin is 1-10 miles.

12. A method according to claim 9, wherein step (b) is practiced by the processor defining different commerce ranges over different time periods of a day.

13. A method according to claim 8, wherein the applications comprise a credit/debit card tool cooperable with the GPS tool and the processor, and wherein step (b) is practiced by identifying user conducted financial transactions and transaction geolocation data with the credit/debit card tool, and wherein the GPS tool indentifies the commerce range based on the transaction geolocation data.

14. A method according to claim 8, wherein step (c) is practiced by the processor setting the zoom level to a default zoom level when the GPS tool indicates that the mobile device is outside of the commerce range.

15. A mobile device comprising:
a memory storing applications;
a processor communicating with the memory and executing the applications;
a GPS tool cooperable with the processor and accessing geolocation data of the mobile device, the GPS tool identifying a commerce range for the mobile device;
a user interface communicating with the processor; and
a display cooperable with the user interface and communicating with the processor,
wherein the GPS tool communicates with the memory to store the geolocation data of the mobile device over a time period, wherein the applications comprise a credit/debit card tool cooperable with the GPS tool and the processor that identifies user conducted financial transactions and transaction geolocation data, and wherein the GPS tool indentifies the commerce range based on the stored geolocation data and the transaction geolocation data, and
wherein the applications further comprise a map tool that is cooperable with the GPS tool and the processor such that the processor displays a map on the display at a zoom level that is determined based on the commerce range.
